(19) United States
(12) Patent Application Publication
(10) Pub. No.: US 2017/0034376 A1
(43) Pub. Date: Feb. 2, 2017

(54) IMAGE PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventor: Yusuke Hashizume, Urayasu Chiba (JP)

(21) Appl. No.: 14/812,145

(22) Filed: Jul. 29, 2015

(51) Int. Cl. H04N 1/00

(52) U.S. Cl. CPC H04N 1/00748; H04N 1/00737; H04N 1/00588; H04N 1/00713; H04N 1/00774; H04N 2201/0081

(57) ABSTRACT

In accordance with an embodiment, an image processing apparatus comprises a conveyance section, a first image reading section and a detection section. The conveyance section conveys a sheet in a first scanning direction. The first image reading section reads an image of the sheet conveyed by the conveyance section per line of a second scanning direction orthogonal to the first scanning direction. The detection section, based on an image signal read by the first image reading section, detects a front end portion and a rear end portion of the sheet in the first scanning direction.

### FIELD

Embodiments described herein relate generally to an image processing apparatus.

### BACKGROUND

It is necessary for an image reading apparatus to decide an image reading timing of a paper for reading an image formed on the paper. The image reading apparatus is equipped with a sensor such as a reflective photosensor to recognize a timing when the paper is conveyed. It is necessary for the image reading apparatus to contain the sensor such as the reflective photosensor, so it is difficult to suppress the cost.

### BRIEF DESCRIPTION OF THE DRAWINGS

FIG. 1 is an external view illustrating an example of an image processing apparatus 500 according to an embodiment;

FIG. 2 is a cross-sectional view illustrating an example of the image processing apparatus 500 according to the embodiment;

FIG. 3 is a block diagram illustrating an example of functional components of an image reading unit 100 according to the embodiment;

FIG. 4 is a view illustrating signal values of image signals with respect to the number of lines of a sheet S in the image reading unit 100 according to the embodiment; and

FIG. 5 is other view illustrating signal values of image signals with respect to the number of lines of the sheet S in the image reading unit 100 according to the embodiment.

### DETAILED DESCRIPTION

An image processing apparatus of an embodiment is equipped with a conveyance section, a first image reading section and a detection section. The conveyance section conveys a sheet in a first scanning direction. The first image reading section reads an image of the sheet conveyed by the conveyance section per line of a second scanning direction orthogonal to the first scanning direction. The detection section, based on an image signal read by the first image reading section, detects a front end portion and a rear end portion of the sheet in the first scanning direction.

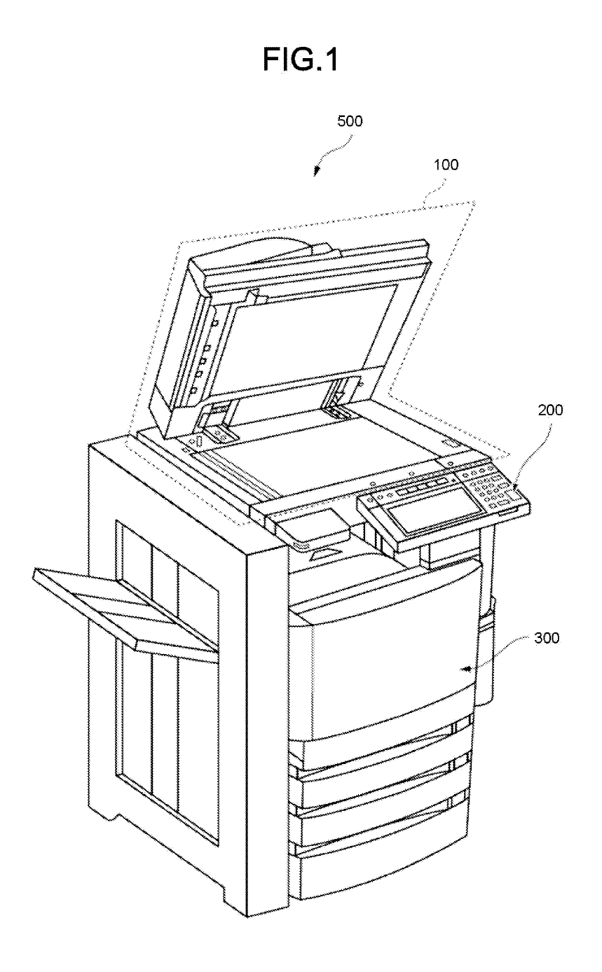

Hereinafter, the image processing apparatus of the embodiment is described with reference to the accompanying drawings. FIG. 1 is an external view illustrating an example of an image processing apparatus 500 of the embodiment. The image processing apparatus 500 is, for example, an MFP (Multi Function Peripheral). The image processing apparatus 500, for example, reads a plurality of sheets to generate digital data and an image file. The sheet is, for example, a document, a paper on which characters and pictures are recorded and the like. The sheet may be anything as long as it can be read by the reading processing apparatus 500. The reading processing apparatus 500 includes an image reading unit 100, a control panel unit 200 and an image forming unit 300.

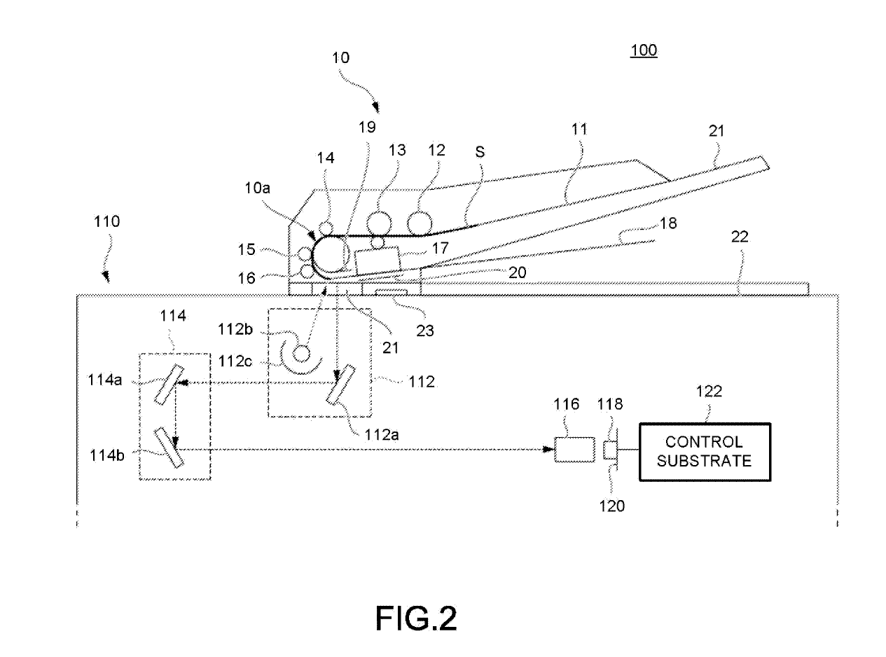

Next, with reference to FIG. 2, constitutions of an image reading in the image processing apparatus of the embodiment are described. FIG. 2 is a cross-sectional view illustrating an example of the image processing apparatus 500 according to the embodiment.

The image processing apparatus 500 of the embodiment is an image processing apparatus of a duplex reading type for reading a first surface and a second surface of a sheet S. The image processing apparatus 500 reads the first surface of the sheet S by a first image reading section. The image processing apparatus 500 reads the second surface serving as a rear surface of the first surface of the sheet S by a second image reading section. The image processing apparatus 500 of the embodiment is described as an image processing apparatus of a duplex reading type; however, it may be also applicable to an image processing apparatus of a simplex reading type.

The image reading unit 100 is equipped with a first image reading section 110 and a scanner module 17. Further, the image reading unit 100 is equipped with an ADF (Automatic Document Feeder) 10. The ADF 10 conveys the sheet S to the first image reading section 110 and the scanner module 17.

The ADF 10 includes a document tray 11, a conveyance mechanism (12, 13, 14, 15 and 16) and a paper discharge tray 18. The conveyance mechanism is equipped with a pickup roller 12, a resist roller 13 and a plurality of conveyance rollers 14, 15 and 16. The conveyance mechanism is equipped with a driving section (for example, a motor, a solenoid and the like) for generating a torque to rotate the rollers 12, 13, 14, 15 and 16.

The sheets S serving as reading targets of the first image reading section 110 and the scanner module 17 are placed on the document tray 11. The pickup roller 12 picks up the sheet S from the document tray 11 and sends the picked up sheet S towards a conveyance path. The resist roller 13 aligns a front end position of the sheet S conveyed from the pickup roller 12 and then sends the sheet S towards the conveyance rollers 14, 15 and 16. The conveyance rollers 14, 15 and 16 convey the sheet S conveyed from the resist roller 13 towards a reading window glass 21 side and the scanner module 17 side. The sheet S passes through an image reading range of the first image reading section 110, and then passes through an image reading range of the scanner module 17. Afterwards, the sheet S is discharged to the paper discharge tray 18.

The first image reading section 110 is equipped with the reading window glass 21, a platen glass 22 and a white reference plate 23. The first image reading section 110 includes a first carriage 112, a second carriage 114 and a lens 116. Moreover, the first image reading section 110 is equipped with a CCD (Charge Coupled Device) sensor 118. The first image reading section 110 is equipped with a CCD sensor substrate 120 and a control substrate 122. The first image reading section 110 can carry out a reading processing by an image scanner of a reduction optical system. In the following embodiment, that the first image reading section 110 is the reduction optical system is described. However, there may be a case in which the first image reading section 110 is constituted by an image scanner of a unit magnification optical system using a CIS (Contact Image Sensor). The first image reading section 110 using the unit magnification optical system can realize the same operations as the first image reading section 110 of the reduction optical system described below.

The reading window glass 21 is an opening for reading the image of the sheet S conveyed by the ADF 10. The platen glass 22 is a document placing table on which the sheet S is placed.

The first carriage 112 is equipped with a reflective plate 112a, a light source 112b and a reflector 112c. The light source 112b emits the light. The light emitted from the light source 112b passes through the reading window glass 21 and is guided to the conveyance path. The light reflected by the sheet S is guided to the reflective plate 112a. The reflective plate 112a reflects the incident light to the second carriage 114.

The second carriage 114 is equipped with a reflective plate 114a and a reflective plate 114b. The light reflected by the reflective plate 112a enters to the reflective plate 114a. The reflective plate 114a reflects the incident light towards the reflective plate 114b. The light reflected by the reflective plate 114a enters to the reflective plate 114b. The reflective plate 114b reflects the incident light to the lens 116. The light entering into the lens 116 is guided to the CCD sensor 118.

The CCD sensor 118 generates a CCD signal based on the incident light. The CCD signal is converted into an image signal through a CCD sensor substrate 120.

The CCD sensor 118 includes a plurality of image capturing elements arranged in a vertical scanning direction and functions as the first image reading section. The CCD sensor 118 outputs the image signal based on a horizontal synchronization signal input from a controller (not shown). The CCD sensor 118 outputs the image signal read simultaneously by the plurality of image capturing elements as the image signal corresponding to one line. The CCD sensor 118, if a next horizontal synchronization signal is input, reads the image corresponding to next line and outputs the image signal. In this way, the CCD sensor 118 sequentially outputs the image signal corresponding to one line of the sheet S read in a vertical scanning direction. A horizontal scanning line direction is a direction parallel to the conveyance direction of the sheet S by the ADF 10. The vertical scanning line direction is a direction orthogonal to the conveyance direction of the sheet S by the ADF 10.

The scanner module 17 has the same constitution as the first image reading section 110. The scanner module 17 is equipped with a light source (second light source) and a CCD sensor (second image reading section). The CCD sensor contains a plurality of image capturing elements arranged in a vertical scanning line direction. The scanner module 17 guides the light emitted from the light source to the second surface of the sheet S. The scanner module 17, based on the reflected light from the sheet S, photoelectrically converts the light signal into an electrical signal and then outputs the image signal. In this way, the scanner module 17 functions as the second image reading section.

The scanner module 17 outputs the image signal based on a horizontal synchronization signal input from a controller (not shown). The scanner module 17, if a next horizontal synchronization signal is input, reads the image corresponding to next line and outputs the image signal. In this way, the scanner module 17 sequentially outputs the image signal corresponding to one line of the sheet S read in a vertical scanning direction.

In the embodiment, the CCD sensor 118 reads the image of the surface serving as the first surface of the sheet S moving at the surface of the reading window glass 21. The scanner module 17 (second image reading section) reads the image of the rear surface serving as the second surface of the sheet S. In this way, the image reading unit 100 can read surface image and rear surface image from both surfaces of the sheet S through making the sheet S pass through the conveyance path only once.

In the ADF 10, a first light diffusion section 19 is arranged at the part which is emitted from the light source 112b and passes through the conveyance path and the reading window glass 21. The first light diffusion section 19 is a light diffusion member, and may be a member which does not specularly reflect the incident light. The first light diffusion section 19 may be a member containing a material absorbing the incident light. For example, the first light diffusion section 19 is a black plate.

In a state in which the sheet S is conveyed onto the reading window glass 21, the light passing through the reading window glass 21 is reflected by the sheet S. on the other hand, in a state in which the sheet S is not conveyed onto the reading window glass 21, the light passing through the reading window glass 21 is diffused by the first light diffusion section 19. As a result, the light intensity in the CCD sensor 118 becomes a high value in a state in which the sheet S is conveyed onto the reading window glass 21.

In the ADF 10, the scanner module 17 is arranged at the downstream side of the first image reading section 110 in the conveyance direction. A second light diffusion section 20 is arranged at the part which is emitted from the second light source in the scanner module 17 and passes through the conveyance path. The second light diffusion section 20, similar to the first light diffusion section 19, diffuses the light emitted from the second light source. As a result, the light intensity in the CCD sensor 118 in a state in which the sheet S is conveyed to the scanner module 17 is higher than the light intensity in a state in which the sheet S is not conveyed to the scanner module 17.

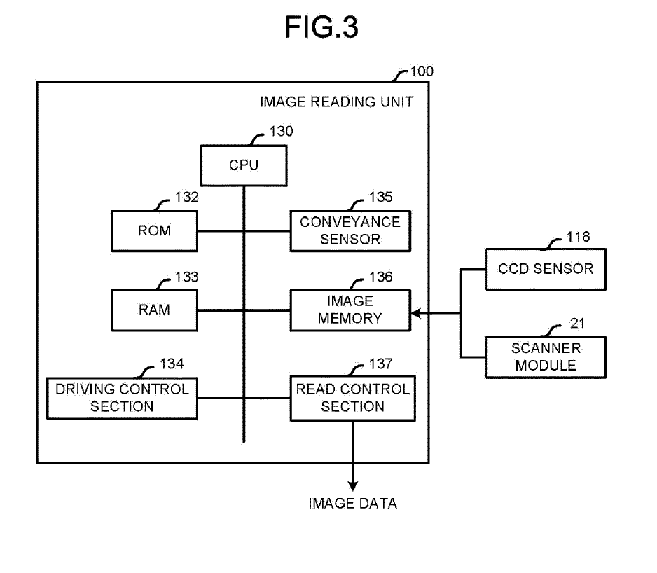

Next, with reference to FIG. 3, functional components of the image reading unit 100 according to the embodiment are described. FIG. 3 is a block diagram illustrating an example of the functional components of the image reading unit 100 according to the embodiment.

The image reading unit 100 is equipped with a CPU 130, a ROM 132 and a RAM 133. Further, the image reading unit 100 is equipped with a driving control section 134, a conveyance sensor 135, an image memory 136 and a read control section 137 (detection section).

The CPU 130, based on the information stored in the ROM 132 or the RAM 133, controls each constitution section contained in the image reading unit 100.

Predetermined operation programs relating to the CPU 130 are stored in the ROM 132. Data specified by the ROM 132 and CPU 130 is stored in the RAM 133.

The driving control section 134 controls a driving section for driving each of rollers (12, 13, 14, 15 and 16) contained in the conveyance mechanism.

The conveyance sensor 135 contains a sensor detecting the sheet S conveyed by the conveyance mechanism. The conveyance sensor 135 outputs the detection result to the driving control section 134.

The image memory 136 is a storage section for temporarily storing the image signal read by the first image reading section 110 and the scanner module 17.

The read control section 137 reads the image signal read by the CCD sensor 118 and the image signal read by the scanner module 17. The read control section 137, based on the image signal generated by the CCD sensor 118, controls the acquisition of the image signal generated by the scanner module 17. The read control section 137, by acquiring a valid image signal within the image signals generated by the scanner module 17, supplies the acquired valid image signal to the image forming unit 300.

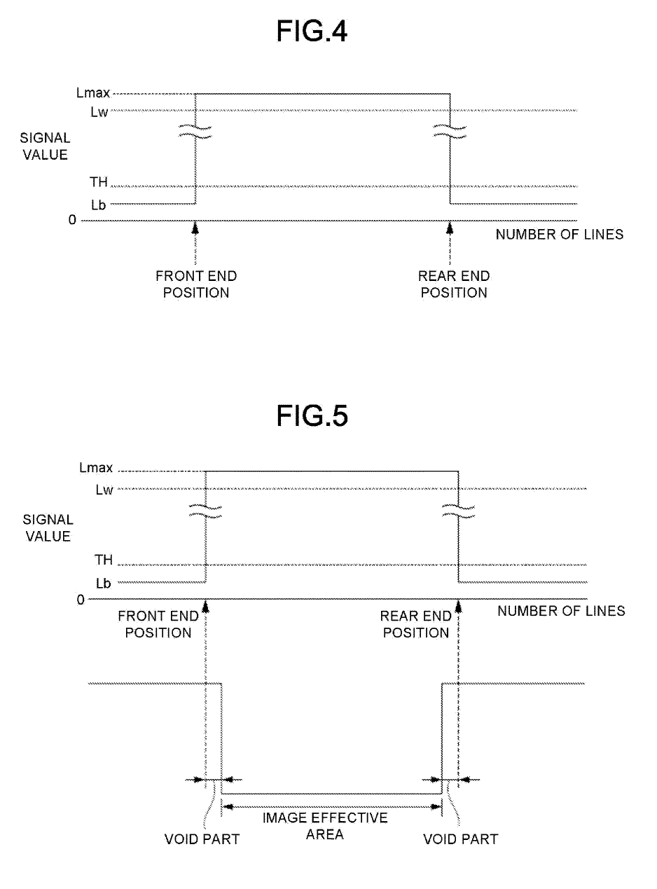

Hereinafter, a processing of detecting the end portion of the sheet S in the first image reading section 110 is described. FIG. 4 is a view illustrating signal values of the image signals with respect to the number of the lines of the sheet S in the image reading unit 100 of the embodiment.

The CCD sensor 118 continues generating the image signal based on the received light during the period when the image processing apparatus 500 starts to operate. When the front end position of the sheet S is conveyed to the image reading range of the first image reading section 110, the sheet S is irradiated with the light. The light reflected by the sheet S is guided to the CCD sensor 118 through the first carriage 112, the second carriage 114 and the lens 116. That is, the light reflected by the front end position of the sheet S is guided to the CCD sensor 118.

The CCD sensor 118 generates the image signal based on image density of the sheet S. In a case in which the sheet S is white, the CCD sensor 118 generates an image signal Lw of the image density corresponding to the white. The image signal Lw is a value lower than an image signal Lmax generated at the time of directly receiving the light emitted from the light source 112b by the CCD sensor 118.

The image signal Lw detected from the CCD sensor 118 is read by the read control section 137. The read control section 137 compares a predetermined threshold value TH and the image signal Lw supplied from the CCD sensor 118. The read control section 137 determines that the image signal Lw is higher than the determined threshold value TH. As a result, the read control section 137 determines that the front end position of the sheet S arrives at the image reading range.

During the period when the sheet S is irradiated with the light emitted from the light source 112b, the CCD sensor 118 generates the image signal Lw. If the rear end position of the sheet S passes through the reading window glass 21, the light emitted from the light source 112b enters into the first light diffusion section 19. The light emitted from the light source 112b is diffused by the first light diffusion section 19. In result, the CCD sensor 118 generates an image signal Lb generated when the first light diffusion section 19 is irradiated by the light emitted from the light source 112b. The image signal Lb detected by the CCD sensor 118 is read by the read control section 137. The read control section 137 compares a predetermined threshold value TH and the image signal Lb supplied from the CCD sensor 118. The read control section 137 determines that the image signal Lb is lower than the predetermined threshold value TH. As a result, the read control section 137 determines that the rear end position of the sheet S arrives at the image reading range.

The predetermined threshold value TH is set to be higher than the image signal Lb and lower than the image signal Lw. For example, the image signal Lmax is 255 “dec”, and the image signal Lb is about 10 “dec”. For example, the image signal in a case in which a black image is formed on the sheet S is about 30 “dec”. For example, the predetermined threshold value TH is set between about 10 “dec” and 30 “dec”.

The read control section 137 reads the image signal corresponding to a position from the front end position to the rear end position of the sheet S within the image signals generated by the scanner module 17. In result, the read control section 137 acquires a valid image signal corresponding to an effective image area in the sheet S. The read control section 137 converts the valid image signal into the digital data and then generates the image data.

The read control section 137 acquires the data excluding the data corresponding to predetermined lines of both end positions of the sheet S in the horizontal scanning direction as the valid image data. FIG. 5 is other view illustrating signal values of image signals with respect to the number of lines of the sheet S in the image reading unit 100 of the embodiment.

The read control section 137 compares the image data generated by the CCD sensor 118 and the predetermined threshold value TH to detect both end positions of the sheet S. The read control section 137 excludes the image signal of a predetermined number of lines from the front end position to the rear end side of the sheet S from the valid image signal. The read control section 137 excludes the image signal of a predetermined number of lines from the rear end position to the front end side of the sheet S from the valid image signal. For example, the image signal corresponding to predetermined lines excluded is called as VOID. For example, the VOID part is several mm.

The read control section 137 may replace the image signal corresponding to the VOID part with other image signal. For example, the read control section 137 may replace the image signal corresponding to the VOID part with the image signal based on the white image.

According to at least one embodiment described above, based on the image signal of the vertical scanning direction, the front end portion and the rear end portion of the sheet S in the horizontal scanning direction are detected. In this way, according to the embodiment, it is possible to suppress the cost required for the constitution for detecting the end portion of the sheet S. That is, according to the embodiment, it is possible to use the CCD sensor 118 for reading the image formed on the sheet S to detect the end portion of the sheet S. In this way, according to the embodiment, dedicated members for detecting the end portion of the sheet S can not be required.

According to the embodiment, the dedicated members for detecting the end portion of the sheet S are not required. In result, according to the embodiment, setting positions of the members can be ensured. Moreover, according to the embodiment, a route of harness for transmitting the electrical signal can be ensured. According to the embodiment, the cost of the harness can be suppressed.

According to the embodiment, the front end part of the image of the sheet S is detected, and thus it is unnecessary to adjust the end portion position of the sheet S. As a result, according to the embodiment, an end portion adjustment mechanism of the sheet S can not be required.

According to the embodiment described above, functions of the read control section 137 may be realized by a computer. In this case, programs for realizing the functions are recorded in a computer-readable recording medium. Through reading the programs recorded in the recording medium into a computer system and executing the read programs, the functions of the read control section 137 may be realized. The “computer system” described herein contains an OS and hardware such as peripheral equipments. The “computer-readable recording medium” is a recording device such as a flexible disk. The recording device may be a magnetic optical disk, a ROM, a portable medium such as a CD-ROM, or a hard disk built in the computer system. Further, the “computer-readable recording medium” may be a communication wire. The “computer-readable recording medium” may include a volatile memory inside the computer system. The programs may realize one part of the functions described above. The programs can combine with programs already recorded in the computer system to realize the functions described above.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image processing apparatus, comprising:
a conveyance section configured to convey a sheet in a first scanning direction;
a first image reading section configured to read an image of the sheet conveyed by the conveyance section per line of a second scanning direction orthogonal to the first scanning direction,
wherein, the first image reading section includes a first light source which emits light to a conveyance path for conveying the sheet through the conveyance section, a first light diffusion section which diffuses the light emitted from the first light source, the first light diffusion section being a member which does not specularly reflect incident light and a first light receiving section which receives light reflected by the sheet conveyed in the conveyance path; and
a detection section configured to detect a front end portion and a rear end portion of the sheet in the first scanning direction based on an image signal read by the first image reading section.

2. (canceled)

3. The image processing apparatus according to claim 1, further comprising:
a second image reading section configured to read the image of the sheet conveyed by the conveyance section.

4. The image processing apparatus according to claim 3, wherein
the second image reading section is arranged at the downstream side of the first image reading section in a conveyance direction by the conveyance section.

5. The image processing apparatus according to claim 4, wherein
the second image reading section includes a second light source which emits light to a conveyance path for conveying the sheet through the conveyance section; a second light diffusion section which diffuses the light emitted from the second light source; and a second light receiving section which receives light reflected by the sheet conveyed in the conveyance path.

6. The image processing apparatus according to claim 4, wherein
the detection section, based on position information of front end portion and rear end portion of the sheet in a vertical scanning direction, acquires a valid image data within image data read by the second image reading section.

7. The image processing apparatus according to claim 6, wherein
the detection section, within the image data read by the second image reading section, acquires the image data excluding the image data of a predetermined number of lines from the position of the front end portion to the rear end portion side of the sheet in a horizontal scanning direction and the image data of a predetermined number of lines from the position of the rear end portion to the front end portion side of the sheet in a horizontal scanning direction as valid image data.

8. The image processing apparatus according to claim 7, wherein
the detection section replaces the image data excluded within the image data read by the second image reading section with other image data.

9. The image processing apparatus according to claim 1, wherein
the first image reading section reads an image of a first surface of the sheet; and
the detection section detects the front end portion and the rear end portion of the sheet.

10. The image processing apparatus according to claim 1, wherein
the first image reading section reads the image of the first surface of the sheet, and the second image reading section reads an image of a second surface serving as a rear surface with respect to the first surface.
